(19) United States
(12) Patent Application Publication
(10) Pub. No.: US 2022/0314685 A1
(43) Pub. Date: Oct. 6, 2022

(54) MULTI-SIDED MODULAR ERASABLE WRITING PANEL AND SYSTEM FOR ATTACHMENT THEREOF

(71) Applicant: Comsero, Inc., Thornton, CO (US)

(72) Inventor: Anthony Franco, Broomfield, CO (US)

(73) Assignee: Comsero, Inc., Thornton, CO (US)

(21) Appl. No.: 17/807,941

(22) Filed: Jun. 21, 2022

Related U.S. Application Data
(63) Continuation-in-part of application No. 17/523,402, filed on Nov. 10, 2021.
Application No. 17/523,402 is a continuation of application No. 16/112,630, filed on Aug. 24, 2018, now Pat. No. 11,179,964.
(60) Provisional application No. 62/561,581, filed on Sep. 21, 2017.
(60) Provisional application No. 62/561,570, filed on Sep. 21, 2017.
(60) Provisional application No. 62/561,568, filed on Sep. 21, 2017.
(60) Provisional application No. 62/561,559, filed on Sep. 21, 2017.
(60) Provisional application No. 62/561,550, filed on Sep. 21, 2017.

(51) Int. Cl. B43L 1/00; B43L 3/00; B43L 1/12; B32B 5/18; B32B 27/06; B32B 7/12; B32B 37/12; B32B 38/00

(52) U.S. Cl. CPC B43L 1/00; B43L 3/008; B43L 1/126; B43L 3/004; B32B 5/18; B32B 27/065; B32B 7/12; B32B 37/12; B32B 38/004; B32B 5/32

(57) ABSTRACT

The present invention generally relates to a modular erasable writing panel configured to interconnect with a surface prepared with mounting units. The mounting units provide an interface between a multi-sided modular erasable writing panel and another surface such as a wall, cabinet, or other surface. The writing panel is configured to provide multiple erasable writing surfaces configured to interconnect without adhesive to the mounting units wherein repeated dismounting of the erasable writing surface does not debilitate the adhesive bond between the mounting units and the existing surface. The mounting unit provide micro-suction elements configured to removably interconnect the writing panel with the mounting unit repeatedly without diminishing the holding bond between the mounting unit and the writing panel.

### CROSS REFERENCE TO RELATED APPLICATIONS

This application claims the benefit of U.S. patent application Ser. No. 17/523,402 entitled MICRO-SUCTION REUSABLE AND REPOSITIONABLE WRITING SURFACES and filed on Nov. 10, 2021, which is a continuation of U.S. Pat. No. 11,179,964 entitled MICRO-SUCTION REUSABLE AND REPOSITIONABLE WRITING SURFACES and filed on Aug. 24, 2018, which claims benefit of the following provisional patent applications: U.S. Provisional Patent Application No. 62/561,581 entitled RETRACTABLE BOUNDARY APPARATUS AND SYSTEM and filed on Sep. 21, 2017; U.S. Provisional Patent Application No. 62/561,570 entitled DRY ERASE BOARD ERASER and filed on Sep. 21, 2017; U.S. Provisional Patent Application No. 62/561,568 entitled MODULARLY STACKABLE DRY ERASE PANELS AND SYSTEM THEREOF and filed on Sep. 21, 2017; U.S. Provisional Patent Application No. 62/561,559 entitled MULTI-ANGULAR RECONFIGURABLE HANGING APPARATUS and filed on Sep. 21, 2017; and U.S. Provisional Patent Application No. 62/561,550 entitled RECONFIGURABLE APPARATUS AND SYSTEM FOR MARKING AND DISPLAYING OF ITEMS and filed on Sep. 21, 2017. The entire contents of the foregoing applications are incorporated herein by reference in their entirety for all purposes.

### FIELD OF THE INVENTION

The present invention generally relates to a modular erasable writing panel configured to interconnect with a surface prepared with mounting units. The mounting units provide an interface between a multi-sided modular erasable writing panel and another surface such as a wall, cabinet, or other surface. The writing panel is configured to provide multiple erasable writing surfaces configured to interconnect with the mounting units wherein repeated mounting to the mounting units does not debilitate the interconnection bond between the mounting unit and the writing panel.

### BACKGROUND OF THE INVENTION

Rewritable surfaces such as dry-erase surfaces, wet-erase surfaces, and chalkboards are used for many scenarios including collaboration, teaching, and documenting processes and procedures. Rewritable surfaces are typically limited to fixed surfaces or surfaces permanently mounted to a structure, or surfaces which are configured to be portable or to be carried.

Dry-erase technology typically surrounds the use of a non-permanent pen or marker which uses an erasable ink that adheres to a non-porous surface without binding or being absorbed by the surface. Wet-erase technology typically surrounds the use of markers or pens which use a quick-drying paste as their medium which results in a writing medium which can be erased with a damp cloth or running water for instance.

The nature of certain environments, such as for collaboration, follow practices which allow for participants to write their thoughts, typically in bold marker for purposes of visibility, on an adhesive backed piece of paper and adhere it to the wall wherein the paper is able to be moved and re-adhered to the wall as desired. Due to the nature of the pieces of paper, the paper cannot be erased, and the adhesive backing reduces in grip each time it is removed from the wall. After use, the pieces of papers are documented and thrown in the trash or recycled. Furthermore, a user is limited to the use of one side of the paper as the adhesive is applied only to one of two surfaces of the paper.

There is an identified need to provide a modular and reusable solution to allow users to alternatingly adhere to and remove an erasable writing surface in relation to a desired existing surface such as a wall.

There is a further identified need to allow a user to use one or more surfaces of an erasable panel while allowing a user to removably interconnect any surface of the panel to a surface such as a wall.

There is a further identified need to allow a user to alternatingly remove and adhere an erasable writing surface in relation to a desired surface such as a wall to allow the user to modify the writing surface while it is removed.

### SUMMARY OF THE INVENTION

It is an aspect of certain embodiments of the present invention to provide a modular system of erasable writing surfaces comprising a panel with multiple writing surfaces allowing a user to write on the writing surfaces with writing implements such as dry-erase or wet-erase markers wherein the writing surfaces are easily cleaned thereafter.

It is an aspect of certain embodiments of the present invention to provide an erasable writing panel wherein the writing panel is configured to be removably attached to an existing surface wherein a mounting unit comprises a first mounting surface configured to be interconnected to an existing surface, such as a wall, and the mounting unit comprises a second mounting surface configured to be interconnected with a nonporous surface such as the writing surfaces of the writing panel.

In certain embodiments of the present invention, a mounting unit comprises a surface which comprises micro-suction elements such as those disclosed by U.S. patent application Ser. No. 17/523,402 to Franco (“Franco”), incorporated herein by reference for all purposes. Franco discloses micro-suction elements comprising microscopic caverns or cavities with a flexible coating to render them air-tight, wherein the microscopic caverns or cavities in a layer creates a suction which couples the second mounting surface to a surface such as the nonporous surface of the writing panel. The micro-suction elements in the instant invention are typically configured to be used in shear wherein the mounting unit has a first side interconnected by adhesive to an existing vertical surface, and wherein the writing panel is configured to be removably interconnected with the second surface of the mounting unit in a vertical orientation. However, alternate embodiments wherein the mounting unit is mounted to a non-vertical surface and wherein the writing panel is interconnected with the second surface of the mounting unit resulting in the writing panel being in a non-vertical orientation, are within the spirit and scope of the present invention. The second surface of the mounting unit comprising micro-suction elements is configured to removably interconnect a writing panel with the mounting unit repeatedly without diminishing the holding bond between the second surface of the mounting unit and the writing panel, wherein repeated dismounting of the writing panel does not debilitate the adhesive bond between the mounting unit and the existing surface.

It is an aspect of certain embodiments of the present invention to provide visual indication of the first mounting surface of the mounting unit which is configured to interconnect with an existing surface, and the second mounting surface of the mounting unit which is configured to allow the removable interconnection of a writing panel thereto. In certain embodiments, the first mounting surface or second mounting surface comprises written instructions indicating the mounting surface configured to interconnect with the existing surface and the mounting surface configured to receive the writing panel. In alternate embodiments, the first side of the mounting unit comprises a first color and the second side of the mounting unit comprises a second color, thereby differentiating the first mounting surface from the second mounting surface.

It is an aspect of certain embodiments of the present invention to provide a writing panel comprising multiple writing surfaces configured to be erasably written upon and, wherein each of the multiple writing surfaces is configured to interconnect with micro-suction elements of a mounting unit. Although embodiments disclosed herein typically surround a planar sheet comprising a first writing surface and a second writing surface, alternate embodiments comprising multiple writing surfaces such as a rectangular prism, a cube, a pyramidal form, or other polyhedrons—are within the spirit and scope of the present invention.

It is an aspect of certain embodiments of the present invention to provide an erasable writing panel comprising multiple surfaces wherein a first surface exhibits a printed background to enhance or augment a user's interaction with the writing panel. In certain embodiments, guidelines are printed such as found on lined paper or a calendar. Alternate embodiments comprise printed images such as an ornamental image, or an outlined image encouraging a user to color in the image. Further embodiments including written word, such as a restaurant menu or musical score, are within the spirit and scope of the present invention.

It is an aspect of certain embodiments of the present invention to provide an erasable writing panel comprising a geometric shape such as square or rectangle, or a decorative shape such as one mimicking an organic shape, animal shape, or other desired ornamental design. It is a further aspect of certain embodiments to provide mounting units comprising a shape such as a square, rectangle, triangle, circle, or oval shape. Further still, embodiments wherein the mounting unit comprises a decorative shape such as an animal shape or other ornamental design are within the spirit and scope of the present invention.

In certain embodiments a writing panel is removably interconnected to existing surface through the use of a singular mounting unit. Such a mounting unit of certain embodiments is configured to interconnect with a singular writing panel. In alternate embodiments a single mounting unit is configured to have multiple writing panels interconnected thereto. In further embodiments, multiple mounting units are configured to receive multiple writing panels wherein the writing panels are interconnected to the mounting units in an organized fashion such as in a rectangular array or other configuration as desired.

These and other advantages will be apparent from the disclosure of the inventions contained herein. The above-described embodiments, objectives, and configurations are neither complete nor exhaustive. Other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1A—A front view of certain embodiments of the present invention comprising a writing panel

FIG. 1B—A side view of certain embodiments of the present invention comprising a writing panel

FIG. 1C—A detail view of the writing panel shown in FIG. 1B

FIG. 2—An exploded perspective view of certain embodiments comprising a writing panel

FIG. 3—An exploded perspective view of certain embodiments comprising a writing panel

FIG. 4—A front view of certain embodiments comprising a writing panel

FIG. 5A—A front view of certain embodiments comprising a mounting unit

FIG. 5B—A side view of certain embodiments comprising a mounting unit

FIG. 5C—A detail view of certain embodiments of the mounting unit shown in FIG. 5B

FIG. 6—A side view of certain embodiments comprising a system for the removable interconnection of a writing panel to an existing surface

FIG. 7—A front view of certain embodiments comprising a system for the removable interconnection of a plurality of writing panels to a surface

FIG. 8—An exploded perspective view of certain embodiments comprising a mounting unit

FIG. 9—A detail view of certain embodiments of the mounting unit shown in FIG. 5B

FIG. 10A—A front view of certain embodiments of a mounting unit

FIG. 10B—A front view of certain embodiments of a mounting unit

FIG. 11A—A front view of certain embodiments of a mounting unit comprising at least one curvilinear edge

FIG. 11B—A front view of certain embodiments of a mounting unit comprising a plurality of curvilinear edges

FIG. 11C—A front view of certain embodiments of a mounting unit comprising at least one curvilinear edge and at least one linear edge

FIG. 11D—A front view of certain embodiments of a mounting unit comprising an ornamental shape

### DETAILED DESCRIPTION OF VARIOUS EMBODIMENTS

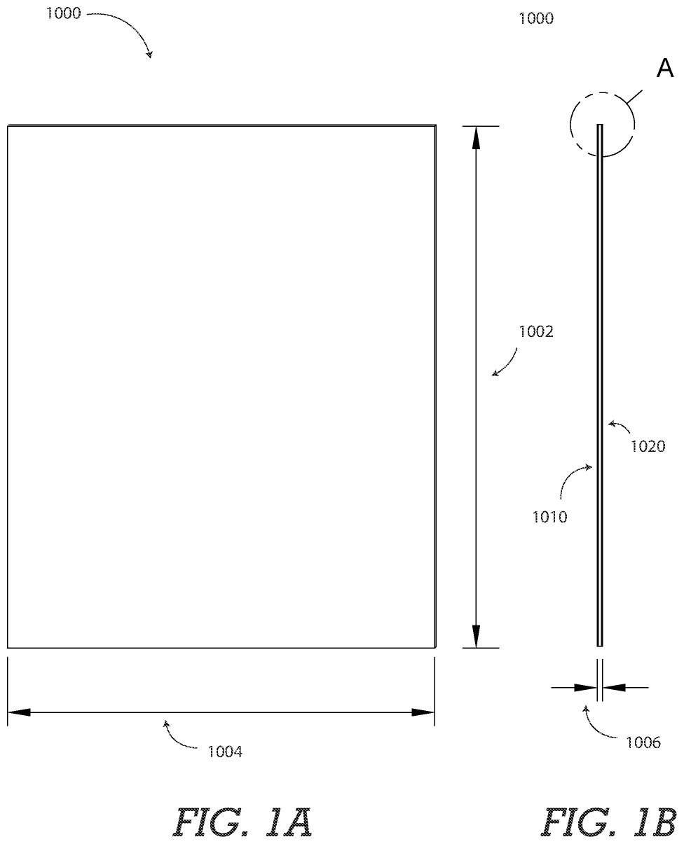

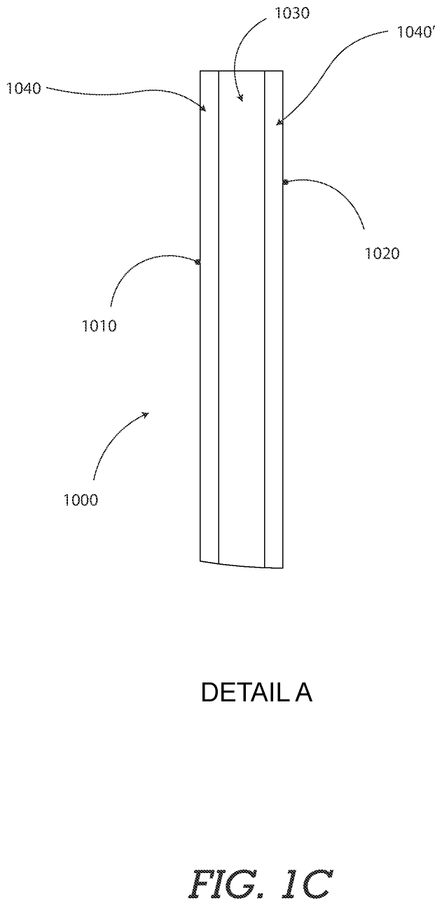

Certain embodiments of the present invention, as shown in FIG. 1A-FIG. 1C for example, comprise an erasable writing panel 1000 having a length 1002, a width 1004, and a thickness 1006. The writing panel comprises a first writing surface 1010, a second writing surface 1020, and a core 1030 therebetween, wherein the surfaces 1010,1020 and the core 1030 are interconnected to form a unitary writing panel 1000. In certain embodiments, first writing surface 1010 comprises a nonporous layer 1040, and second writing surface 1020 comprises a nonporous layer 1040′, each configured for writing on with a dry-erase or wet-erase writing implement. In certain embodiments, the writing surfaces 1010,1020 comprise a polyester-based composition. Alternate embodiments wherein a writing surface comprises a non-porous material such as glass, melamine, steel, aluminum, porcelain, enamel-on-steel, or polypropylene are within the spirit and scope of the present invention. In certain embodiments, core 1030, nonporous layer 1040, and nonporous layer 1040′ are impervious to or unaffected by water.

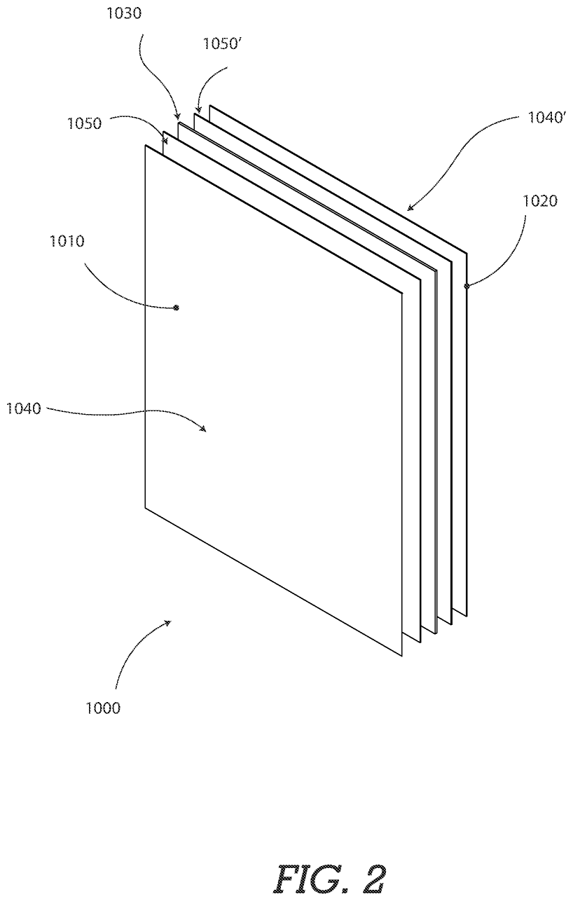

Certain embodiments of the present invention, shown in FIG. 2 for example, comprise a writing panel 1000 which comprises a first writing surface 1010, wherein the first writing surface comprises nonporous layer 1040 which is transparent. A first printable surface 1050 is interconnected to the panel between the first writing surface 1010 and the core material 1030, wherein the first printable surface 1050 is viewable through the first writing surface 1010. As desired, embodiments of the first printable surface 1050 include guidelines, background images, or written word. Certain embodiments comprise a printable surface 1050 comprising printed matter which a user interacts with such as, but not limited to: a calendar template, ruled lines for writing, line-drawings for coloring, or a restaurant menu. Further embodiments within the spirit and scope of the present invention include printed matter which solely serves as a background image such as a photograph or decorative pattern for instance. Certain embodiments of the present invention comprise a second printable 1050′ surface between the core material 1030 and the second writing surface 1020.

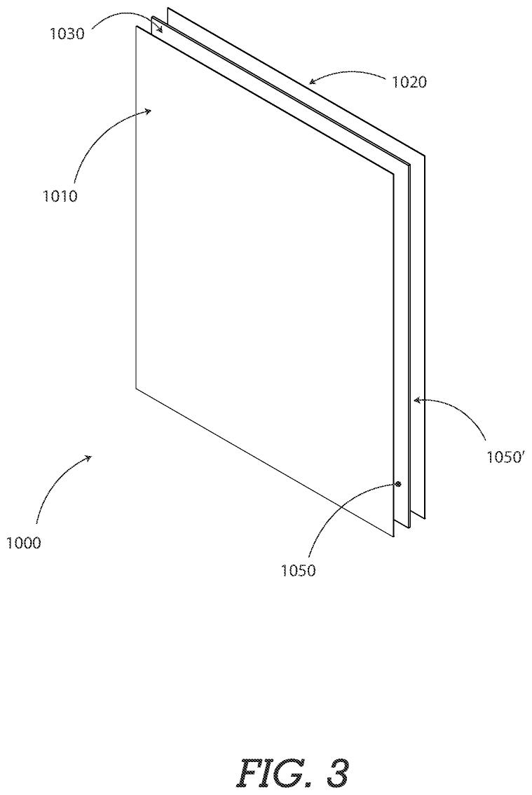

In certain embodiments, as shown in FIG. 3 for instance, a writing panel 1000 comprises a core material 1030 which comprises polystyrene. Alternate embodiments comprise a core material comprising compounds such as, but not limited to, polyethylene, urethane, polyurethane, styrene, materials of polymeric or metallic composition, wood or wood composite, or other organic or organic composite materials while in keeping with the spirit and scope of the present invention. In certain embodiments, core material 1030 comprises a printable surface 1050 wherein the printable surface is viewable through the first writing surface 1010. In certain embodiments, writing panel 1000 comprises a transparent, translucent, or opaque glass or acrylic sheet material.

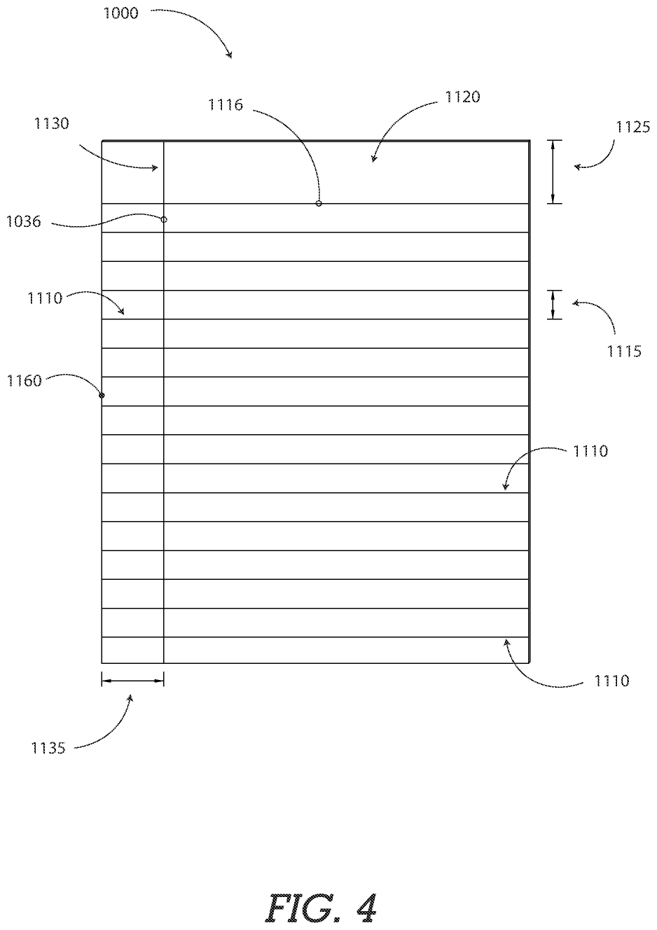

Certain embodiments, as shown in FIG. 4 for instance, of the present invention comprise a writing panel 1000 comprising a printable layer having at least a first horizontal line 1110 printed thereon, while alternate embodiments comprise plurality of horizontal lines 1110 printed thereon. The horizontal lines 1110 are printed substantially equidistant to each other with a vertical spacing 1115. However, alternate embodiments comprising horizontal lines with various spacings are within the spirit and scope of the present invention. In certain embodiments the top of the first printable surface comprises a margin 1120 with a height 1125 greater than the vertical spacing 1115 of the horizontal lines. In certain embodiments the margin 1120 comprises a height 1125 equal to or greater than twice the vertical spacing 1115 of the horizontal lines. The writing panel further comprises a vertical line 1130 offset from a first lateral edge 1060 of the writing panel. In certain embodiments the vertical line 1130 is offset from the first lateral edge 1060 by a horizontal distance 1135 equal to the height 1125 of the margin, however alternative embodiments wherein the horizontal distance 1135 is not equal to the height 1125 of the margin are within the spirit and scope of the present invention. In certain embodiments the horizontal lines 1110 are printed in a first color 1116 and the vertical line 1130 is printed in a second color 1136. In certain embodiments the horizontal lines are blue, and the vertical line is red, however the colors of the horizontal lines and the vertical line in alternative embodiments are not limited thereto.

In certain embodiments, referencing FIG. 1A, a writing panel comprises a rectangular form wherein the length 1002 and the width 1004 are predetermined by a user for manufacture. In certain embodiments a writing panel comprises a standard paper size such as about 215.9 mm×279.4 mm (8.5 in ×11 in), a square form such as about 30.48 mm×30.48 mm (12 in×12 in), other rectangular sizes such as about 22.86 mm×27.94 mm (9 in ×11 in), or other sizes as desired. A writing panel, although shown in embodiments herein in rectangular forms, is not limited thereto. Writing panels of certain embodiments comprise at least one curvilinear side, at least one linear side, or a combination thereof while in keeping with the spirit and scope of the present invention. Furthermore, writing panels of alternate embodiments comprising geometric, ornamental, organic or irregular shapes are within the spirit and scope of the present invention. For example, the writing panel may comprise a geometric shape, such as a circle, oval, pyramid, pentagon, hexagon, octagon, or polygon, am ornamental shape such as a star or heart shape, an organic or irregular shape such as the outline of an animal, apple, or automobile.

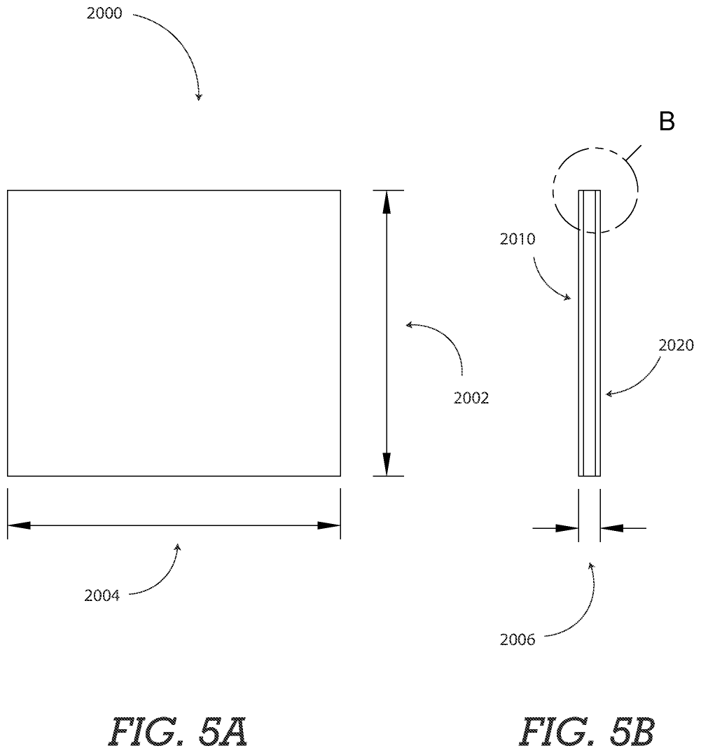

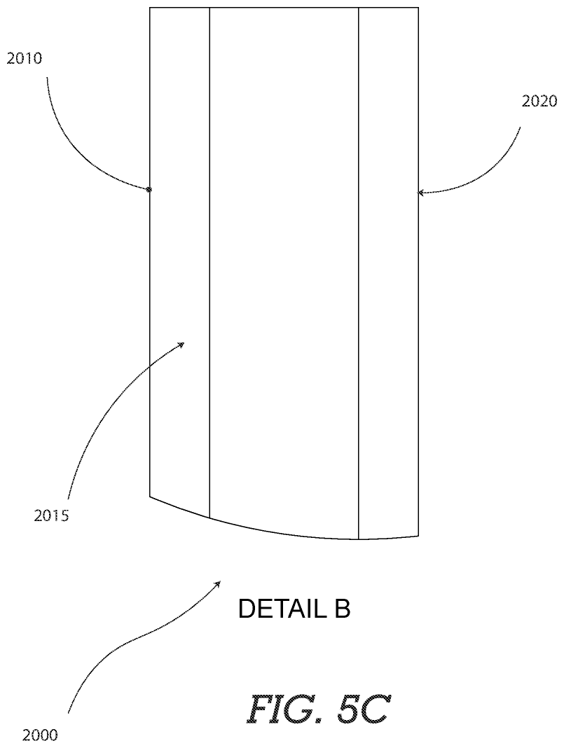

Certain embodiments of the present invention comprise a system, as shown in FIG. 1-FIG. 6 for instance, for the modular and removable attachment of a writing panel to a surface such as a wall, but not limited thereto. The system comprises a writing panel 1000, such as shown in FIGS. 1A-FIG. 4, and a mounting unit 2000. As shown in FIGS. 5A and 5B, the mounting unit 2000 comprises a length 2002, a width 2004, and a thickness 2006. As shown in FIG. 5C, the mounting unit 2000 comprises a first mounting surface 2010 configured to interconnect with existing surface 6000. The existing surface 6000 may comprise drywall, painted drywall or other painted surface, metal, wood or wood composition, glass, stone or synthetic stone, plastic, or other surface materials typically found in a home or office environment. The first mounting surface 2010 of certain embodiments comprises a pressure-sensitive adhesive layer 2015 that is adapted to adhere to existing surface 6000 while also being adapted to be removed without damage to existing surface 6000. The adhesive layer 2015 of various embodiments comprises a natural adhesive such as vegetable starch, natural resins, or animal-based adhesives—commonly referred to as bioadhesives. In alternate embodiments the adhesive layer 2015 comprises a synthetic adhesive such as elastomers, thermoplastics, emulsions, or thermosets including but not limited to epoxy, polyurethane, cyanoacrylate, and acrylic polymers. The adhesives listed herein are not intended to be exhaustive and alternate embodiments including known adhesives not listed herein are within the spirit and scope of the present invention. In certain embodiments, the pull-off strength of adhesive layer 2015 from existing surface 6000 is about 0.2-1 psi. In certain embodiments, the pull-off strength of adhesive layer 2015 from existing surface 6000 is about 1-2 psi. In certain other embodiments, the pull-off strength of adhesive layer 2015 from existing surface 6000 is greater than 2 psi.

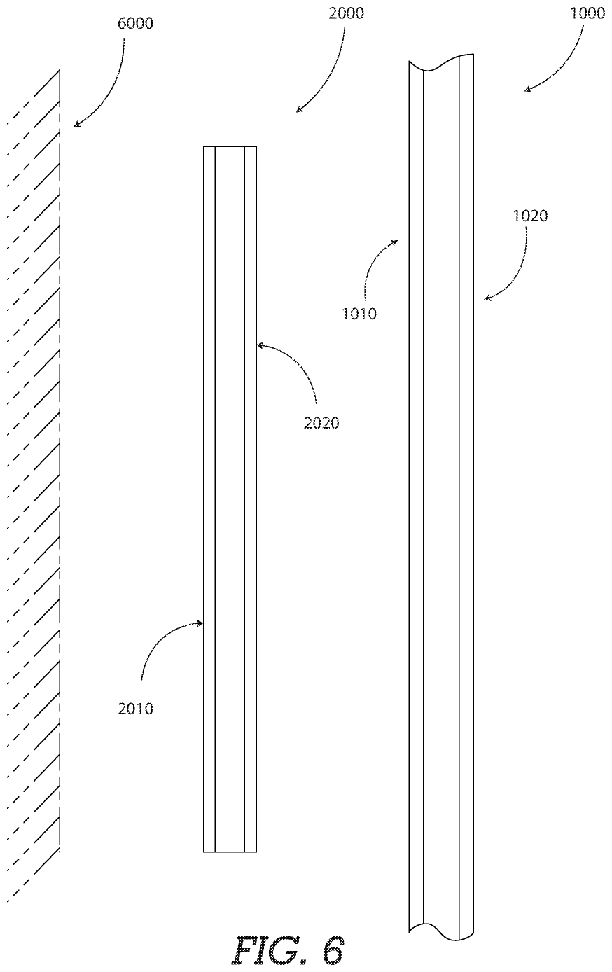

In certain embodiments, such as shown in FIG. 5A-FIG. 6, mounting unit 2000 comprises a thickness 2006 which provides a standoff between writing panel 1000 and existing surface 6000. The standoff prevents the writing panel 1000 from contacting existing surface 6000 and smudging any writing on the writing surfaces 1010,1020 on to existing surface 6000. The standoff also allows a user to grasp the edge of writing panel 1000 and remove it from mounting unit 2000. In certain embodiments, thickness 2006 is about 1 to 40 mils. In certain other embodiments, thickness 2006 is about 40 to 80 mils. In certain other embodiments, thickness 2006 is about 80 to 160 mils. In certain other embodiments, thickness 2006 is about 160 to 320 mils. In certain other embodiments, thickness 2006 is greater than about 320 mils.

In certain embodiments, a mounting unit 2000 further comprises a second mounting surface 2020 configured to allow the removable interconnectability of a non-porous material thereto, such as a first writing surface 1010 or second writing surface 1020 of a writing panel 1000. In certain embodiments, the second mounting surface 2020 utilizes suction to establish an interconnection between the second mounting surface and the writing panel. In certain embodiments, the second mounting surface 2020 comprises a plurality of micro-suction or nano-suction elements as disclosed by Franco. In certain embodiments, the second mounting surface 2020 comprises a microsphere adhesive or pressure sensitive acrylate. In certain embodiments, the second mounting surface 2020 comprises a tacky silicone film, a tacky polyurethane film, or another tacky polymer film. In certain embodiments, the pull-off strength of writing surface 1010 or 1020 from second mounting surface 2020 is about 0.1-0.5 psi. In certain embodiments, the pull-off strength of writing surface 1010 or 1020 from second mounting surface 2020 is about 0.5-1 psi. In certain other embodiments, the pull-off strength of writing surface 1010 or 1020 from second mounting surface 2020 is about 1-2 psi.

In a preferred embodiment, the pull-off strength between second mounting surface 2020 and first writing surface 1010 or second writing surface 1020 of writing panel 1000 is less than the pull-off adhesion strength of the first adhesive layer 2015 when interconnected with existing surface 6000. Thus, mounting unit 2000 will remain adhered to existing surface 6000 through the repeated mounting and removal of writing panel 1000 to the second mounting surface 2020.

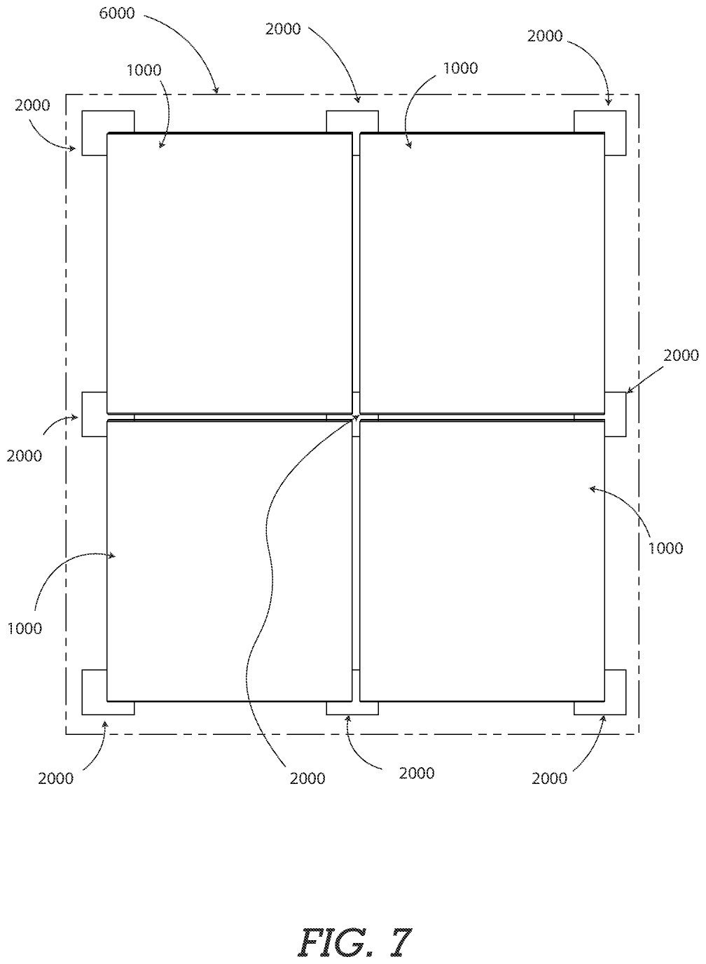

Mounting units 2000 as disclosed herein are configured to be used as single mounting units configured to receive a writing panel 1000, or as a series or array of mounting units configured to receive a single writing panel 1000, or a plurality of writing panels 1000 in a variety of configurations as shown for instance in FIG. 7. In certain embodiments for instance, a plurality of mounting units 2000 are interconnected to existing surface 6000 in a rectangular array wherein each mounting unit 2000 is configured to receive up to four writing panels 1000. In certain embodiments, an array of mounting units 2000 is configured wherein each mounting unit 2000 is configured to receive a single writing unit 1000. Further embodiments comprising alternate configurations wherein each mounting unit 2000 is configured to receive 2, 3, or more than 4 writing panels each 1000 are within the spirit and scope of the present invention.

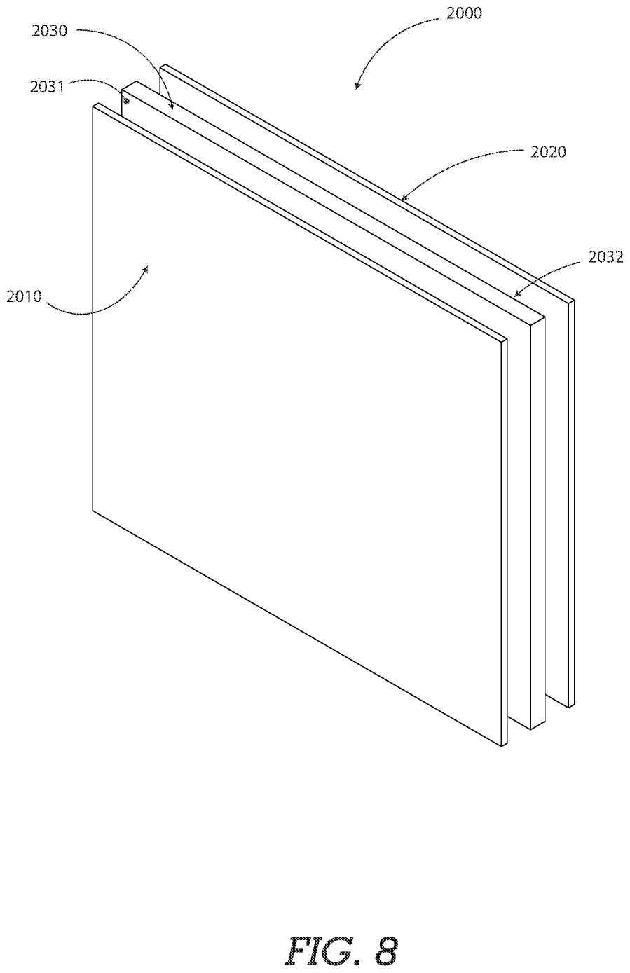

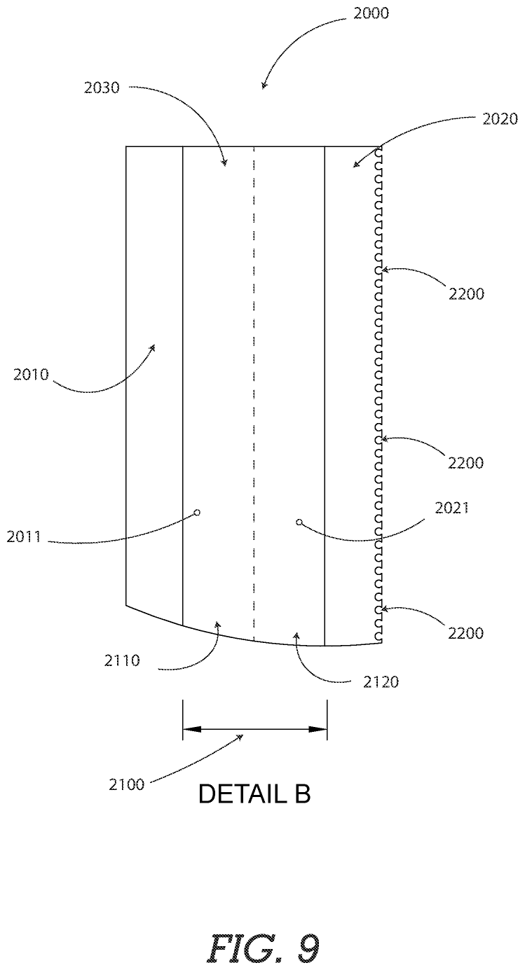

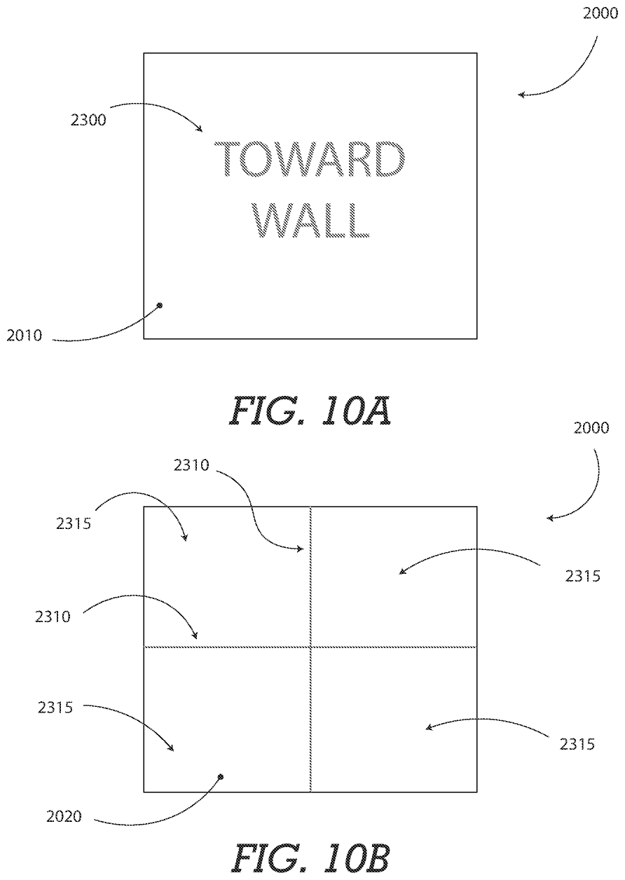

In certain embodiments, such as shown in FIG. 8-FIG. 9, the mounting unit 2000 further comprises a pliant layer 2030 interconnected between the first mounting surface 2010 and the second mounting surface 2020. In embodiments as shown, the first mounting surface 2010 is interconnected to a first side 2031 of the pliant layer 2030, and the second mounting surface 2020 is interconnected to a second side 2032 of the pliant layer. In certain embodiments, second mounting surface 2020 comprises micro-cavities 2200 in the second side 2032 of the pliant layer 2030. In certain embodiments the second mounting surface 2020 is integral with the pliant layer 2030. As used herein, the term “pliant” means that the layer or combination of layers is capable of generally conforming to contours of existing surface 6000 and/or contours of writing panel 1000. This pliant characteristic allows the second mounting surface 2020 to maintain a substantially continuous contact with existing surface 6000 and/or writing panel 1000.

In certain embodiments, as shown in FIG. 6-FIG. 9 for instance, the mounting unit 2000 comprises a first side 2010 configured to be interconnected with existing surface 6000, wherein the first side 2010 comprises a first color 2011 visible from the first side 2010. The second side 2020 of the mounting unit, configured to allow the removable interconnection of the writing panel 1000 thereto, comprises a second color 2021 visible from the second side 2020. The colors of the sides of the mounting unit differentiates the first side 2010 configured to be interconnected with existing surface 6000 with an adhesive, and the second side 2020 configured to allow the removable interconnection of the writing panel 1000 thereto. In certain embodiments, as shown in FIG. 9 for instance, the pliant layer 2030 comprises a thickness 2100 wherein a first portion 2110 of the thickness adjacent to the first side 2010 of the mounting unit comprises the first color 2011, and a second portion 2120 of the thickness of adjacent to the second side 2020 of the mounting unit comprise the second color 2021. Thus, the differentiation of the first color from the second color can be made from the first side and second side, or alternatively from viewing the thickness 2100 of the pliant layer 2030. In certain embodiments, pliant layer 2030 comprises a polymeric foam, but is not limited thereto. The polymeric foam may comprise ethylene-vinyl acetate foam, low-density polyethylene foam, nitrile rubber foam, polychloroprene foam, polypropylene foam, polystyrene foam, polyurethane foam, polyvinyl chloride foam, microcellular foam, or porous rubber. In certain embodiments, the pliant layer 2030 comprises two or more layers of polymeric foam of the same or different materials. For example, in certain embodiments, the first portion 2110 of pliant layer 2030 comprises a first layer comprising polyethylene foam and the second portion 2120 of pliant layer 2030 comprises a second layer comprising polyvinyl chloride foam. The foam layers are interconnected by an adhesive layer. In certain other embodiments, the pliant layer 2030 comprises wool or synthetic felt.

In certain embodiments a mounting unit comprises a surface having printed matter upon the surface. For instance, in certain embodiments, a first surface 2010 comprising adhesive configured to be interconnected to an existing surface, comprises printed instructions 2300 such as “toward wall” printed on the first surface. In certain embodiments, a second surface 2020 comprising micro-suction elements, comprises printed lines 2310 configured to define quadrants 2315 of the second surface as guidelines for the interconnection of the corners of a plurality of writing panels to a single mounting unit 2000.

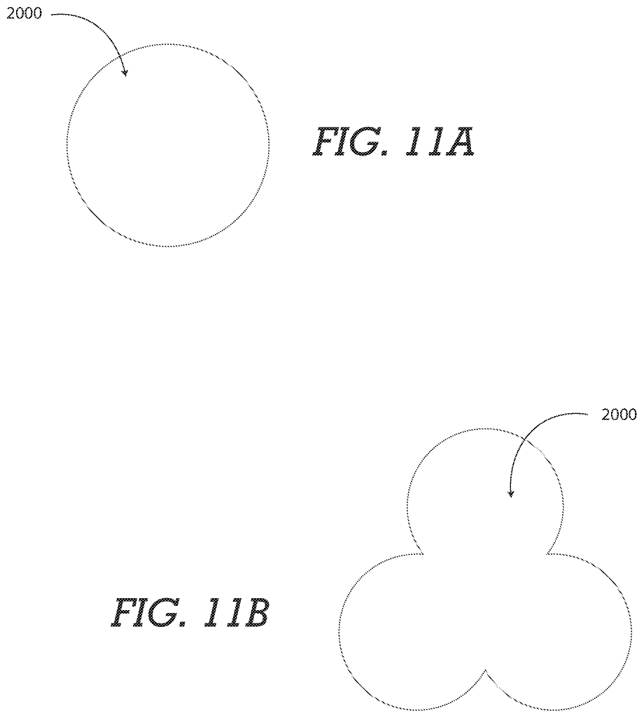

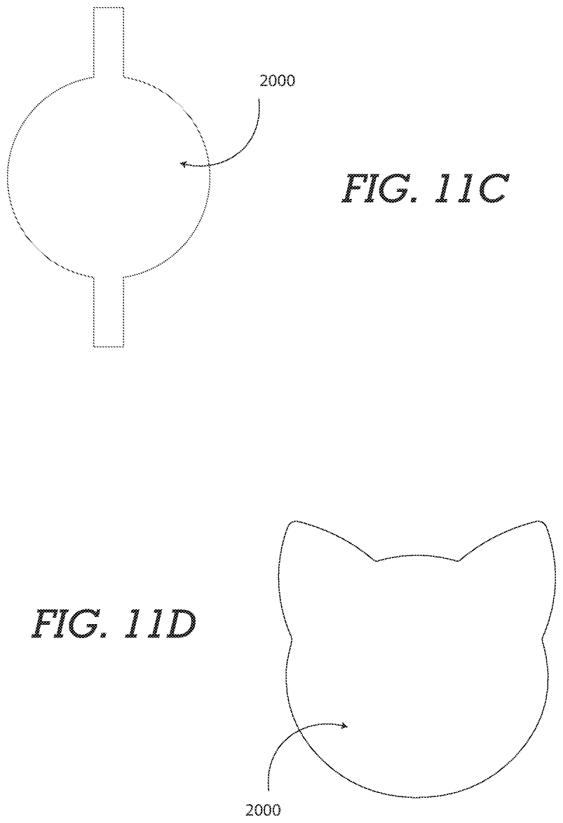

While embodiments thus far have shown mounting units having rectilinear or rectangular forms, alternate embodiments comprising alternate geometric shapes are within the spirit and scope of the present invention. In certain embodiments a mounting unit comprises at least one curvilinear edge such as shown in FIG. 11A. Embodiments comprising a single curvilinear edge, multiple curvilinear edges such as shown in FIG. 11B, or at least one curvilinear edge combined with at least one linear edge such as shown in FIG. 11C are within the spirit and scope of the present invention. In certain embodiments, a mounting unit 2000 such as shown in FIG. 11D comprises a geometric, ornamental, organic, or irregular shape. For example, the mounting unit 2000 may comprise a geometric shape, such as a circle, oval, pyramid, pentagon, hexagon, octagon, or polygon, am ornamental shape such as a star or heart shape, an organic or irregular shape such as the outline of an animal, apple, or automobile.

In certain embodiments, the mounting unit is the same shape as the writing panel and is the same size as the writing panel. In certain embodiments, the mounting unit is the same shape as the writing panel but of a smaller size such that when the writing panel is interconnected to the mounting unit, the perimeter of the writing panel overhangs or hides the perimeter of the mounting unit. Furthermore, in certain embodiments, mounting unit 2000 comprises a color, decorative pattern, or photograph.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as additional items.

What is claimed is:

1. A modular erasable writing panel system comprising:
a writing panel comprising:
a first nonporous writing surface;
a second nonporous writing surface; and
a core between the first writing surface and the second writing surface,
wherein the first writing surface, core, and second writing surface form a unitary panel;
a first mounting unit comprising:
a first mounting surface comprising an adhesive adapted to interconnect with an existing surface;
a second mounting surface comprising micro-suction elements adapted to interconnect with the first writing surface and the second writing surface; and
a pliant layer between the first mounting surface and the second mounting surface,
wherein the first mounting surface is interconnected to a first side of the pliant layer, and the second mounting surface is interconnected to a second side of the pliant layer.

2. The system of claim 1, wherein the pliant layer comprises at least one layer of foam.

3. The system of claim 1, wherein the first side of the pliant layer comprises a first color visible from the first mounting surface, and the second side of the pliant layer comprises a second color visible from the second mounting surface.

4. The system of claim 1, further comprising a first printable surface between the core and the first writing surface, wherein the first printable surface is configured to be viewed through the first writing surface.

5. The system of claim 4, wherein the first printable surface comprises a first surface of the core.

6. The system of claim 4, wherein the first printable surface comprises at least one of a color, decorative pattern, or photograph.

7. The system of claim 1, wherein the perimeter of the first mounting unit comprises at least one of a geometric, ornamental, organic, or irregular shape.

8. The system of claim 7, wherein the perimeter of the writing panel comprises at least one of a geometric, ornamental, organic, or irregular shape.

9. The system of claim 7, wherein the second mounting surface comprises at least one of a color, decorative pattern, or photograph.

10. The system of claim 1, wherein the second mounting surface comprises a first linear guideline on the second mounting surface.

11. The system of claim 10, wherein the second mounting surface comprises a second linear guideline on the second mounting surface, and wherein the second linear guideline is perpendicular to the first linear guideline.

12. A mounting unit for use with a modular erasable writing panel system, the writing panel comprising a first nonporous writing surface and a second nonporous writing surface, the mounting unit comprising:
a pliant layer comprising a first side and a second side;
wherein the first side of the pliant layer comprises an adhesive adapted to adhere to an existing surface;
wherein the second side of the pliant layer comprises micro-suction elements adapted to interconnect with the first nonporous writing surface of a writing panel; and
wherein the first side of the pliant layer is adapted remain adhered to the existing surface when the writing panel is disconnected from the second side of the pliant layer.

13. The mounting unit of claim 12, wherein the pliant layer comprises at least one layer of foam.

14. The mounting unit of claim 12, wherein the pliant layer is at least about 160 to 400 mils thick.

15. The mounting unit of claim 12, wherein the first side of the pliant layer comprises a first color, and the second side of the pliant material comprises a second color.

16. The mounting unit of claim 12, wherein the perimeter of the mounting unit comprises at least one of a geometric, ornamental, organic, or irregular shape.

17. The mounting unit of claim 12, wherein the second side of the pliant layer comprises at least one of a color, decorative pattern, or photograph.

18. The mounting unit of claim 12, wherein the second side of the pliant layer comprises a first linear guideline.

19. The mounting unit of claim 19, wherein the second side of the pliant layer comprises a second linear guideline, wherein the second linear guideline is perpendicular to the first linear guideline.

20. The mounting unit of claim 12, wherein the first side of the pliant layer comprises written instructions.
